(19) United States
(12) Patent Application Publication
(10) Pub. No.: US 2023/0146336 A1
(43) Pub. Date: May 11, 2023

(54) DIRECTLY IDENTIFYING ITEMS FROM AN ITEM CATALOG SATISFYING A RECEIVED QUERY USING A MODEL DETERMINING MEASURES OF SIMILARITY BETWEEN ITEMS IN THE ITEM CATALOG AND THE QUERY

(71) Applicant: Maplebear Inc. (dba Instacart), San Francisco, CA (US)

(72) Inventors: Haixun Wang, Palo Alto, CA (US); Taesik Na, Issaquah, WA (US); Tejaswi Tenneti, Fremont, CA (US); Saurav Manchanda, Minneapolis, MN (US); Min Xie, Santa Clara, CA (US); Chuan Lei, Los Altos, CA (US)

(21) Appl. No.: 17/524,491

(22) Filed: Nov. 11, 2021

(51) Int. Cl. G06Q 30/06; G06N 20/00

(52) U.S. Cl. CPC G06Q 30/0603; G06N 20/00

(57) ABSTRACT

To simplify retrieval of items from a database that at least partially satisfy a received query, an online concierge system trains a model that outputs scores for items from the database without initially retrieving items for evaluation by the model. The online concierge system pre-trains the model using natural language inputs corresponding to items from the database, with a natural language input including masked words that the model is trained to predict. Subsequently, the model is refined using multi-task training where a task is trained to predict scores for items from the received query. The online concierge system selects items for display in response to the received query based on the predicted scores.

### BACKGROUND

This disclosure relates generally to identifying items from a database based on a query received by an online concierge system, and more specifically to the online concierge system identifying items at least partially matching the query from the database without separately retrieving items from the database and subsequently ranking the retrieved items.

In current online concierge systems, shoppers (or “pickers”) fulfill orders at a physical warehouse, such as a retailer, on behalf of customers as part of an online shopping concierge service. An online concierge system provides an interface to a customer identifying items offered by a physical warehouse and receives selections of one or more items for an order from the customer. In current online concierge systems, the shoppers may be sent to various warehouses with instructions to fulfill orders for items, and the shoppers then find the items included in the customer order in a warehouse.

To generate an order for fulfillment by an online concierge system, a user provides a query including one or more terms. From a database of items offered by a warehouse, the online concierge system identifies items with attributes that at least partially match one or more terms in the query. Conventional online concierge systems retrieve a set of candidate items from the database based on the received query. Subsequently, a conventional online concierge system ranks the set of candidate items retrieved from the database and displays items at least partially matching the received search query based on the ranking. However, retrieval of candidate items from the database is computationally intensive for the online concierge system and can result in larger latencies. Additionally, many natural language processing-based models are able to better generalize and conserve computational resources.

### SUMMARY

An online concierge system obtains an item catalog of items offered by one or more warehouses. In some embodiments, the online concierge system obtains an item catalog from each warehouse, with an item catalog from a warehouse identifying items offered by the warehouse. The item catalog includes different entries, with each entry including information identifying an item (e.g., an item identifier, an item name) and one or more attributes of the item. Example attributes of an item include: one or more keywords, a brand offering the item, a manufacturer of the item, a type of the item, a price of the item, a quantity of the item, a size of the item and any other suitable information. Additionally, one or more attributes of an item may be specified by the online concierge system for the item and included in the entry for the item in the item catalog. Example attributes specified by the online concierge system for an item include: a category for the item, one or more sub-categories for the item, and any other suitable information for the item.

In various embodiments, the online concierge system stores the item catalog in a database identifying an item and attributes of the item. For example, the database storing the item catalog is a relational table including an entry for each item, with an item identifier identifying an item and its corresponding entry in the database. The entry in the database corresponding to an includes one or more fields, with a field corresponding go the item identifier of the item, and other fields corresponding to an attribute of the item and including a value for the attribute. In various embodiments, an attribute has multiple values, so a field corresponding to the attribute includes each value for the attribute.

The online concierge system creates templates for natural language descriptions of attributes for each item of the item catalog from the database storing the item catalog. A template includes the item identifier of an item, a name or a description of an attribute, a value of the attribute for the item, and one or more natural language terms. In various embodiments, each natural language description is a sentence including an item identifier, a description of an attribute, and a value of the attribute for the item in specific positions. For example, each word in the sentence has a specific position identifying its location in the sentence, with certain positions corresponding to a position in the sentence where information from fields of an entry in the database for an item is included. This allows the online concierge system to identify specific words or phrases in a template and to identify placement of an item identifier, an attribute description, and one or more vales of the attribute in the template. The online concierge system generates one or more templates for each attribute in various embodiments and stores one or more templates corresponding to an attribute in association with a name or another identifier of the attribute. Hence, creating templates allows the online concierge system to generate natural language data describing various attributes of an item.

From the stored item catalog and the templates, the online concierge system 102 generates a training set including examples, with each example comprising a natural language description of an item. An example includes an item identifier, a name or a description of an attribute, and one or more values of the attributes. In various embodiments, the online concierge system generates an example for the training set by selecting a template corresponding to an attribute, accessing the stored database describing the item catalog, and generating the example by including values from corresponding fields of the database into position of the template corresponding to the fields of the database. For example, a template identifies a position in a sentence for an item identifier and a position in a sentence for a value of a specific attribute, with the sentence including a text description of the specific attribute. The online concierge system generates examples by accessing the item catalog, identifying an entry in the item catalog, and including a value of the item identifier and a value of the specific attribute from fields of the identified entry in the template.

In various embodiments, the online concierge system generates one or more examples for the training set based on prior searches received from users. For example, a template specifies a natural language description of a term in a query received by the online concierge system, a warehouse whose items were searched, and item identifiers that were included in one or more orders after a query including the term was received. For example, a template is a sentence “The top five purchased items for the query [term] at [warehouse] are [item identifier], [item identifier], [item identifier], [item identifier], and [item identifier].” In the preceding example [term] denotes a term included in a query, [warehouse] denotes an identifier of a warehouse that was searched, and [item identifier] denotes item identifiers for items included in orders received by the online concierge system after receiving the query. Additionally, the online concierge system may leverage any suitable source of information about attributes of items. For example, the online concierge system, creates templates that specify a natural language description of an item that include an item identifier and identify one or more additional items from a taxonomy of items that identifies relationships between items or from co-occurrences of an item with the one or more additional items in one or more recipes that include a set of items and instructions for combining the set of items. Hence, the templates may be used to generate examples of natural language descriptions attributes of an item or additional items related to the item for the training set from any source maintained by, or accessible by, the online concierge system storing information identifying the item and identifying attributes, as well as values of the attributes.

From the training set of natural language examples including item identifiers and values of attributes for items of the item catalog, the online concierge system trains a corpus model. In various embodiments, the corpus model is a masked language model where certain words, or tokens, in an example of the training set are masked, and the corpus model predicts the words that are masked from unmasked words in the example. For example, the online concierge system replaces certain words in an example of the training set with a mask token, with the example including the one or more mask tokens input into the corpus model, which outputs a predicted word for each mask token. However, in other embodiments, the corpus model is any model configured to receive natural language input comprising one or more tokens (e.g., words) and to map the tokens into embeddings in a vector space.

The online concierge system also obtains selection training data from prior searches performed by users. The selection training data includes selection examples that each include a query term and a plurality of pairs that each include an item identifier and an affinity score between an item corresponding to the item identifier and the query term. In various embodiments, a selection example includes a pair for each combination of item identifier of an item in the item catalog and the affinity score between the item corresponding to the item identifier and the query term. The affinity score between the item corresponding to the item identifier and the query term may be determined from rates at which users selected the item via the online concierge system after providing the query term to the online concierge system. In other embodiments, the affinity score may be specified by one or more reviewers of the online concierge system or determined through any suitable method.

After training the corpus model from the natural language descriptions for items of the training set, the online concierge system trains a mapping layer that receives the output of the corpus model. The mapping layer is a linear layer with a number of outputs equal to a number of unique item identifiers of the item catalog. In various embodiments, the online concierge system trains the mapping layer as a multiclass multilabel classification, with a number of classes that equals the number of unique item identifiers of the item catalog. In various embodiments, the mapping layer has an output node corresponding to each item identifier of the item catalog, with a weight between an output node and the output of the corpus model based on a token embedding for the item identifier corresponding to the output node. In various embodiments, the predicted similarity between the output of the corpus model and an output node corresponding to an item identifier is a dot product of the output of the corpus model and the weight between the output of the corpus model and the output node corresponding to the item identifier, while in other embodiments any suitable measure of similarity (e.g., cosine distance, Euclidian distance) may be determined between the output of the corpus model and the weight between the output node and the output of the corpus model. Hence, the output of the mapping layer is a predicted similarity between the output of the corpus model and each item identifier of the item catalog, allowing the mapping layer to determine predicted similarities between the output of the corpus model, which is an embedding for the input of the corpus model that is a query term, and each item identifier of the item catalog in a single iteration. In contrast, conventional search methods encode the received query term, individually encode different items of the item catalog, and determines similarities between the received query term and the individually encoded items.

To train the mapping layer, the online concierge system applies the model, which comprises the trained corpus model and the mapping layer, to a selection example of the selection training data. The online concierge system determines one or more error terms from differences between a predicted similarity between a query term of the selection example and an item identifier output by the model and the affinity of the query term for the item identifier included in the selection example. An error term may be generated through any suitable loss function, or combination of loss functions, in various embodiments. For example, the loss function is a cross-entropy loss or a mean squared error between a predicted similarity between a query term of the selection example and an item identifier output by the model and the affinity of the query term for the item identifier included in the example. However, in other embodiments, any loss function or combination of loss functions, may be applied to the predicted similarity between the query term of the example and the item identifier output by the model and the affinity of the query term for the item identifier included in the selection example to generate an error term.

The online concierge system backpropagates the one or more error terms through the mapping layer. One or more parameters of the mapping layer are modified through any suitable technique from the backpropagation of the one or more error terms through the layers of the network. For example, weights between the output of the corpus model and output nodes are modified to reduce the one or more error terms. The backpropagation of the one or more error terms is repeated by the online concierge system until the one or more loss functions satisfy one or more criteria. For example, the one or more criteria specify conditions for when the backpropagation of the one or more error terms through the mapping layer is stopped.

In response to the one or more loss functions satisfying the one or more criteria and the online concierge system stopping the backpropagation of the one or more error terms, the online concierge system stores the set of parameters for the mapping layer. For example, the online concierge system stores the weights of connections between nodes in the network as the set of parameters of the mapping layer in a non-transitory computer readable storage medium. Hence, training of the mapping layer allows the online concierge system to generate and to store a neural network, or other machine learning model, that predicts a similarity of a query term to each of multiple item identifiers. In various embodiments, the online concierge system applies the model to each selection example of the selection training data, while in other embodiments the online concierge system applies the model to any suitable number of selection examples of the selection training data.

After training the mapping layer, the online concierge system receives a query including one or more terms. In various embodiments, the query comprises a query token comprising a word or phrase indicating that subsequent tokens are terms in a query. The online concierge system generates an embedding for a term in the query from the trained corpus model. The embedding for the term generated by the corpus model is input into the mapping layer, which generate a predicted similarity between the embedding for the term of the query and each item identifier, based on the token embedding corresponding to each item identifier. The online concierge system selects a set of items based on the predicted similarities. For example, the online concierge system ranks items based on the predicted similarity of their corresponding item identifier to the embedding for the term of the query and selects items having item identifiers having at least a threshold position in the ranking (e.g., having item identifiers within the top 10 positions of the rankings) and displays information identifying the selected items to a user via an interface. In other embodiments, the online concierge system displays information identifying various items in an order corresponding to the ranking of items based on the predicted similarities of their corresponding item identifiers to the embedding for the term of the query.

The corpus model and the mapping layer may additionally or alternatively be trained to output items that are related to an item identifier that the corpus model receives as input. In various embodiments, the online concierge system trains the mapping layer as a multiclass multilabel classification, with a number of classes that equals the number of unique item identifiers of the item catalog. As described above, the mapping layer has an output node corresponding to each item identifier of the item catalog, with a weight between an output node and the output of the corpus model based on a token embedding for the item identifier corresponding to the output node. Hence, the output of the mapping layer is a predicted similarity between the output of the corpus model and each item identifier of the item catalog, allowing the mapping layer to determine predicted similarities between the output of the corpus model, which is an embedding for the input of the corpus model that is an item identifier, and each item identifier of the item catalog in a single iteration. In contrast, conventional search methods encode the received query term, individually encode different items of the item catalog, and determines similarities between the received query term and the individually encoded items.

To train the mapping layer, the online concierge system applies the model, comprising the trained corpus model and the mapping layer, to an example of relationship training data. The relationship training data includes a plurality of examples, with each example comprising an item identifier and pairs that each include an additional item identifier and an affinity score between an item corresponding to the item identifier and an additional item corresponding to the additional item identifier. The affinity score between the item corresponding to the item identifier and the additional item corresponding to the additional item identifier query term may be determined from rates at which the item and the additional item co-occur in orders previously received from users of the online concierge system or co-occur in orders previously fulfilled by the online concierge system. The online concierge system normalizes the rate or the frequency at which the item and the additional item co-occur in previously received orders to determine the affinity score between the item and the additional item in various embodiments. In some embodiments, the online concierge system determines the rate or the frequency of co-occurrence of the item and the additional item in orders received or fulfilled during a specific time interval (e.g., within a threshold amount of time from a current item).

The online concierge system determines one or more error terms from differences between a predicted similarity between an item identifier of the example and an additional item identifier output by the model and the affinity score between the item identifier and the additional item identifier included in the example. An error term may be generated through any suitable loss function, or combination of loss functions, in various embodiments. For example, the loss function is a cross-entropy loss or a mean squared error between a predicted similarity between predicted similarity between an item identifier of the example and an additional item identifier output by the model and the affinity score between the item identifier and the additional item identifier included in the example. However, in other embodiments, any loss function or combination of loss functions, may be applied to the predicted similarity between an item identifier of the example and the additional item identifier output by the model and the affinity score between the item identifier and the additional item identifier included in the example to generate an error term.

The online concierge system backpropagates the one or more error terms through the mapping layer. One or more parameters of the mapping layer are modified through any suitable technique from the backpropagation of the one or more error terms through the layers of the network. For example, weights between the output of the corpus model and output nodes are modified to reduce the one or more error terms. The backpropagation of the one or more error terms is repeated by the online concierge system until the one or more loss functions satisfy one or more criteria. In response to the one or more loss functions satisfying the one or more criteria and the online concierge system stopping the backpropagation of the one or more error terms, the online concierge system stores the set of parameters for the mapping layer. Hence, training of the mapping layer allows the online concierge system to generate and to store a neural network, or other machine learning model, that predicts a similarity of an item identifier to each of multiple additional item identifiers.

In various embodiments, the online concierge system subsequently applies the model comprising the corpus model and the trained mapping layer to a received specific item identifier, generating predicted similarities between the specific item identifier and each item in the item catalog. As further described above, based on the predicted similarities, the online concierge system selects one or more items for display or determines an order in which to display items of the item catalog. In various embodiments, the model receives an input comprising a recommendation token and an item identifier, with the recommendation token indicating that one or more subsequent tokens in the received input are item identifiers. Hence, the online concierge system may receive a query and determine whether tokens in the query are terms (e.g., words or other natural language expressions) or are item identifiers based on whether the query includes the query token or includes the recommendation token, respectively.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is a flowchart of a method for identifying items from a database satisfying a query from scores generated for items in the database, according to one embodiment.

FIG. 5 is an example generation of examples for the training set from an entry in an item catalog, according to one embodiment.

FIG. 6 is a process flow diagram of training a corpus model from natural language descriptions of items, according to one embodiment.

FIG. 7 is a process flow diagram of a model for identifying items from a database satisfying a query from predicted similarities between items in the database and a term in a query, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

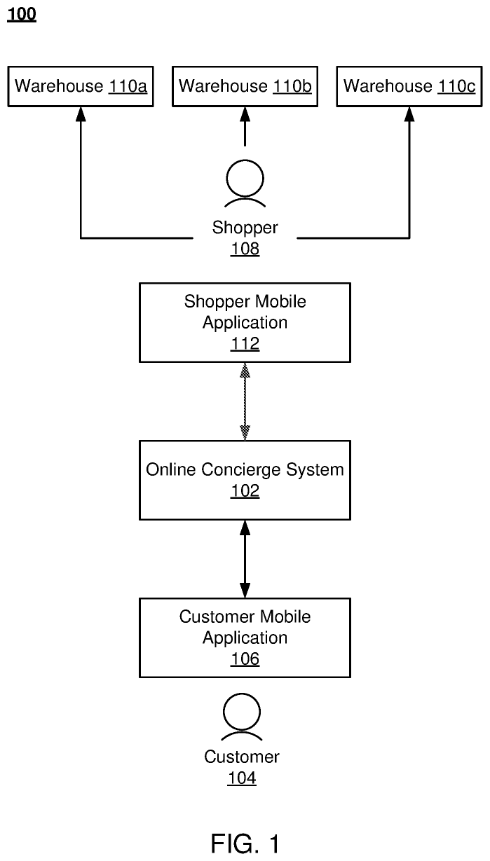

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more customers 104 (only one is shown for the sake of simplicity). An order specifies a list of goods (items or products) to be delivered to the customer 104. The order also specifies the location to which the goods are to be delivered, and a time window during which the goods should be delivered. In some embodiments, the order specifies one or more retailers from which the selected items should be purchased. The customer may use a customer mobile application (CMA) 106 to place the order; the CMA 106 is configured to communicate with the online concierge system 102.

The online concierge system 102 is configured to transmit orders received from customers 104 to one or more shoppers 108. A shopper 108 may be a contractor, employee, or other person (or entity) who is enabled to fulfill orders received by the online concierge system 102. The shopper 108 travels between a warehouse and a delivery location (e.g., the customer's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to customers. Each shopper 108 fulfills an order received from the online concierge system 102 at one or more warehouses 110, delivers the order to the customer 104, or performs both fulfillment and delivery. In one embodiment, shoppers 108 make use of a shopper mobile application 112 which is configured to interact with the online concierge system 102.

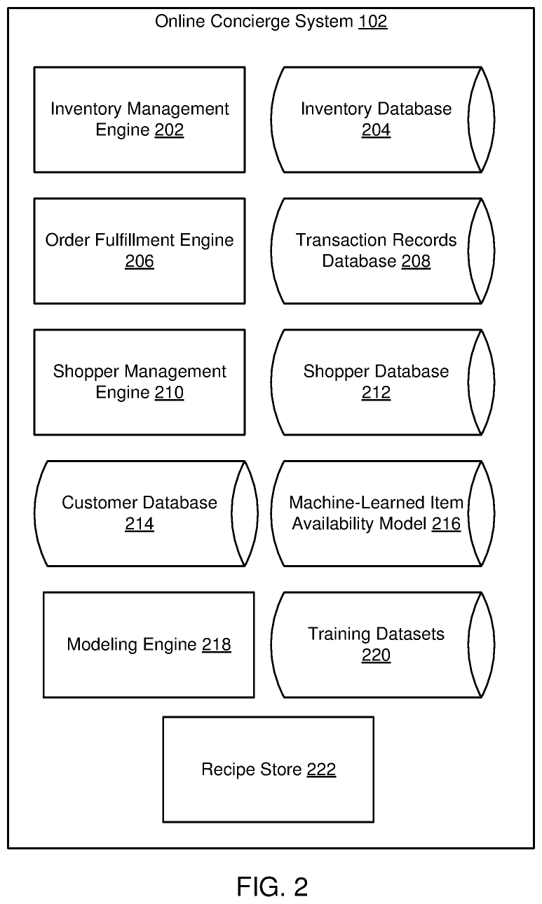

FIG. 2 is a diagram of an online concierge system 102, according to one embodiment. In various embodiments, the online concierge system 102 includes fewer components than those described in conjunction with FIG. 2, while in other embodiments the online concierge system 102 includes different or additional components than those described in conjunction with FIG. 2. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

The inventory database 204 may store an item catalog for a warehouse 110, with the item catalog identifying items offered by the warehouse 110 and attributes of different items. For example, the item catalog is a database with an entry for each item. Each entry includes an item identifier and fields corresponding to different attributes, with a field including a value of the attribute for the item corresponding to the item identifier. In various embodiments, a field may include multiple values for one or more attributes.

In various embodiments, the inventory management engine 202 maintains a taxonomy of items offered for purchase by one or more warehouses 110. For example, the inventory management engine 202 receives an item catalog from a warehouse 110 identifying items offered for purchase by the warehouse 110. From the item catalog, the inventory management engine 202 determines a taxonomy of items offered by the warehouse 110. Different levels in the taxonomy providing different levels of specificity about items included in the levels. For example, the taxonomy includes different categories for items, with categories in different levels of the taxonomy providing different levels of specificity for categories, with lower levels in the hierarchy corresponding to more specific categories, and a lowest level of the hierarchy identifying different specific items. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the warehouse 110 marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from a warehouse 110 in various embodiments. In other embodiments, the inventory management engine 202 applies a trained classification module to an item catalog received from a warehouse 110 to include different items in levels of the taxonomy, so application of the trained classification model associates specific items with generic item descriptions corresponding to levels within the taxonomy.

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a customer 104. Prices set by the order fulfillment engine 206 may or may not be identical to in-store prices determined by retailers (which is the price that customers 104 and shoppers 108 would pay at the retail warehouses). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the customer 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a customer database 214 which stores information describing each customer. This information could include each customer's name, address, gender, shopping preferences, favorite items, stored payment instruments, and so on.

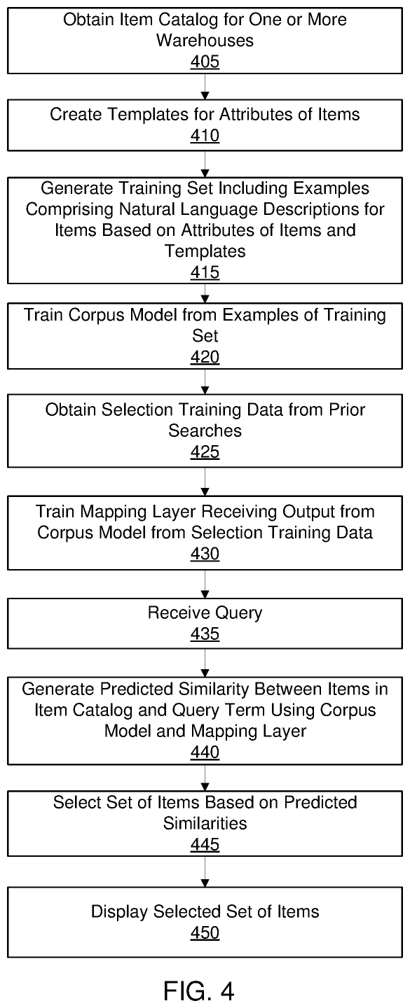

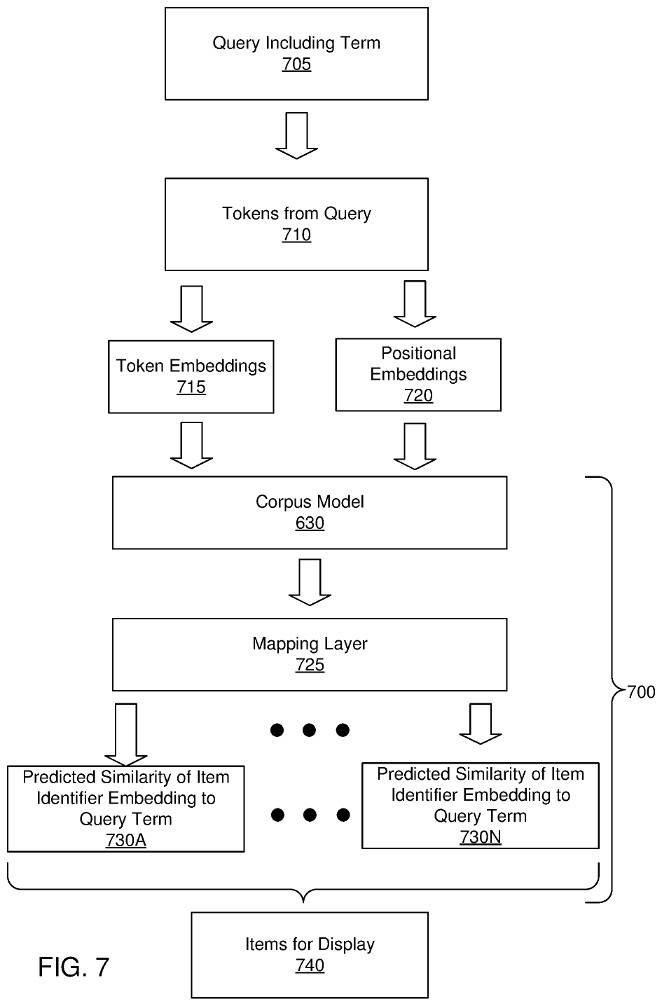

In some embodiments, the order fulfillment engine 206 generates one or more recommendations to a user based on one or more terms in a query received from the user. As further described below in conjunction with FIGS. 4-7, to identify items to recommend to a user, the order fulfillment engine 206 applies a model to the one or more terms in the query and to an item catalog maintained for a warehouse 110. As further described below in conjunction with FIGS. 4 and 7, the model outputs a predicted similarity between one or more terms in the query and each item of the item warehouse 110. Based on the predicted similarities, the order fulfillment engine 206 selects a set of items for display to the user or determines an order in which items of the item catalog are displayed to the user.

### Machine Learning Model

The online concierge system 102 further includes a machine-learned item availability model 216, a modeling engine 218, training datasets 220, a recipe processor 222, and a recipe store 224. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110, also referred to as a predicted availability of the item at the warehouse 110. The machine-learned item availability model 216 may be used to predict item availability for items being displayed to or selected by a customer or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the customer 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 trains and maintains a model to determine predicted similarities between a received query and multiple items, such as each item, in an item catalog maintained for a warehouse 110. As further described below in conjunction with FIGS. 4-7, the model comprises a corpus model and a mapping layer, with the corpus model trained to map tokens, such as words, in a received query to embeddings in a vector space. Training of the corpus model as a masked language model is further described below in conjunction with FIGS. 4-6. An embedding output by the corpus model is input to the mapping layer, which has connections between the corpus model and multiple output nodes. For example, the model includes a number of output nodes equal to a number of items in an item catalog for the warehouse 110. A weight of a connection between an output node and the corpus model is based on an embedding of an item from the item catalog previously generated by the corpus model. The mapping layer determines a dot product, or other measure of similarity, between the embedding output by the corpus model and a weight of a connection. Hence, the output of the mapping layer is predicted similarities between the output of the corpus model and items corresponding to each output node (e.g., to each item of the item catalog). Based on the predicted similarities, the modeling engine 218 or the order fulfillment engine 206 selects items for display to the user, as further described below in conjunction with FIGS. 4 and 7.

In various embodiments, the recipe store 222 includes information identifying recipes obtained by the online concierge system 102. A recipe includes one or more items, such as a plurality of items, a quantity of each item, and may also include information describing how to combine the items in the recipe. Recipes may be obtained from users, third party systems (e.g., websites, applications), or any other suitable source and stored in the recipe store 222. Additionally, each recipe has one or more attributes describing the recipe. Example attributes of a recipe include an amount of time to prepare the recipe, a complexity of the recipe, nutritional information about the recipe, a genre of the recipe, or any other suitable information. Attributes of a recipe may be included in the recipe by a source from which the recipe was received or may be determined by the online concierge system 102 from items in the recipe or other information included in the recipe.

Additionally, the recipe store 222 maintains a recipe graph identifying connections between recipes in the recipe store 222. A connection between a recipe and another recipe indicates that the connected recipes each have one or more common attributes. In some embodiments, a connection between a recipe and another recipe indicates that a user included items from each connected recipe in a common order or included items from each connected recipe in orders the online concierge system received from the user within a threshold amount of time from each other. In various embodiments, each connection between recipes includes a value, with the value providing an indication of a strength of a connection between the recipes.

Further, for various recipes, the recipe store 222 maintains associations between generic item descriptions included in the recipe and specific items offered by different warehouses 110. In some embodiments, the recipe store 222 associates a combination of a warehouse 110 and a specific item offered by the warehouse 110 with a generic item description included in the recipe. However, in other embodiments, the recipe store 222 stores an association between a warehouse 110, a specific item offered by the warehouse 110, a recipe, and a generic item description included in the recipe in any suitable format. Storing associations between warehouses 110, specific items offered by the warehouses 110, recipes, and generic item descriptions included in the recipes in the recipe store 222 allows the online concierge system 102 to more efficiently retrieve specific items offered by a warehouse 110 for a recipe displayed to a user.

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others, or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability, and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

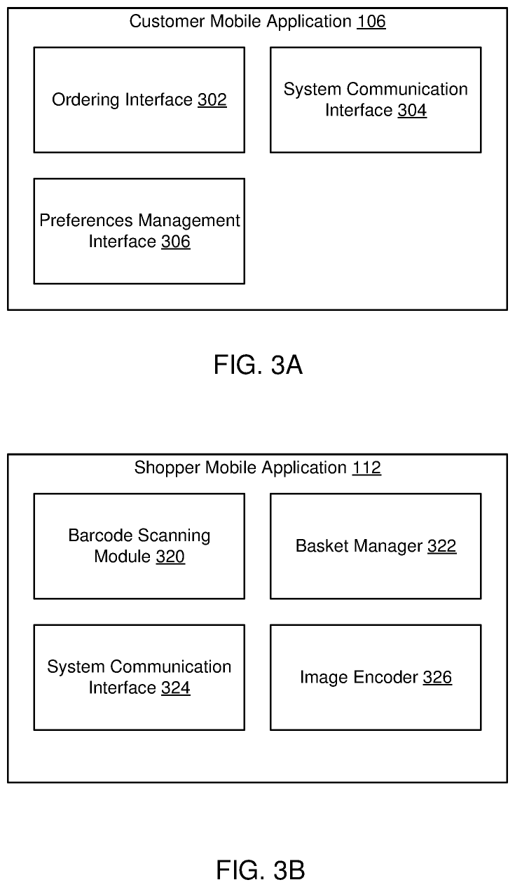

FIG. 3A is a diagram of the customer mobile application (CMA) 106, according to one embodiment. The CMA 106 includes an ordering interface 302, which provides an interactive interface with which the customer 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the customer 104 to manage basic information associated with his/her account, such as his/her home address and payment instruments. The preferences management interface 306 may also allow the customer to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

Directly Identifying Items from a Database Satisfying a Received Query Through a Model

FIG. 4 is a flowchart of one embodiment of a method for identifying items from a database satisfying a query from predicted similarities between items in the database and a term in a query. In various embodiments, the method includes different or additional steps than those described in conjunction with FIG. 4. Further, in some embodiments, the steps of the method may be performed in different orders than the order described in conjunction with FIG. 4. The method described in conjunction with FIG. 4 may be carried out by the online concierge system 102 in various embodiments.

The online concierge system 102 obtains 405 an item catalog of items offered by one or more warehouses 110. In some embodiments, the online concierge system 102 obtains 505 an item catalog from each warehouse 110, with an item catalog from a warehouse identifying items offered by the warehouse 110. The item catalog includes different entries, with each entry including information identifying an item (e.g., an item identifier, an item name) and one or more attributes of the item. Example attributes of an item include: one or more keywords, a brand offering the item, a manufacturer of the item, a type of the item, a price of the item, a quantity of the item, a size of the item and any other suitable information. Additionally, one or more attributes of an item may be specified by the online concierge system 102 for the item and included in the entry for the item in the item catalog. Example attributes specified by the online concierge system 102 for an item include: a category for the item, one or more sub-categories for the item, and any other suitable information for the item.

In various embodiments, the online concierge system 102 stores the item catalog in a database identifying an item and attributes of the item. For example, the database storing the item catalog is a relational table including an entry for each item, with an item identifier identifying an item and its corresponding entry in the database. The entry in the database corresponding to an includes one or more fields, with a field corresponding go the item identifier of the item, and other fields corresponding to an attribute of the item and including a value for the attribute. In various embodiments, an attribute has multiple values, so a field corresponding to the attribute includes each value for the attribute.

The online concierge system 102 generates 410 templates for natural language descriptions of attributes for each item of the item catalog from the database storing the item catalog. A template includes the item identifier of an item, a name or a description of an attribute, a value of the attribute for the item, and one or more natural language terms. In various embodiments, each natural language description is a sentence including an item identifier, a description of an attribute, and a value of the attribute for the item in specific positions. For example, each word in the sentence has a specific position identifying its location in the sentence, with certain positions corresponding to a position in the sentence where information from fields of an entry in the database for an item is included. This allows the online concierge system 102 to identify specific words or phrases in a template and to identify placement of an item identifier, an attribute description, and one or more vales of the attribute in the template. The online concierge system 102 generates 410 one or more templates for each attribute in various embodiments and stores one or more templates corresponding to an attribute in association with a name or another identifier of the attribute. Hence, generating 410 templates allows the online concierge system 102 to generate natural language data describing various attributes of an item.

From the stored item catalog and the generated templates, the online concierge system 102 generates 415 a training set including examples, with each example comprising a natural language description of an item. An example includes an item identifier, a name or a description of an attribute, and one or more values of the attributes. In various embodiments, the online concierge system 102 generates 415 an example for the training set by selecting a template corresponding to an attribute, accessing the stored database describing the item catalog, and generating the example by including values from corresponding fields of the database into position of the template corresponding to the fields of the database. For example, a template identifies a position in a sentence for an item identifier and a position in a sentence for a value of a specific attribute, with the sentence including a text description of the specific attribute. The online concierge system 102 generates 415 examples by accessing the item catalog, identifying an entry in the item catalog, and including a value of the item identifier and a value of the specific attribute from fields of the identified entry in the template.

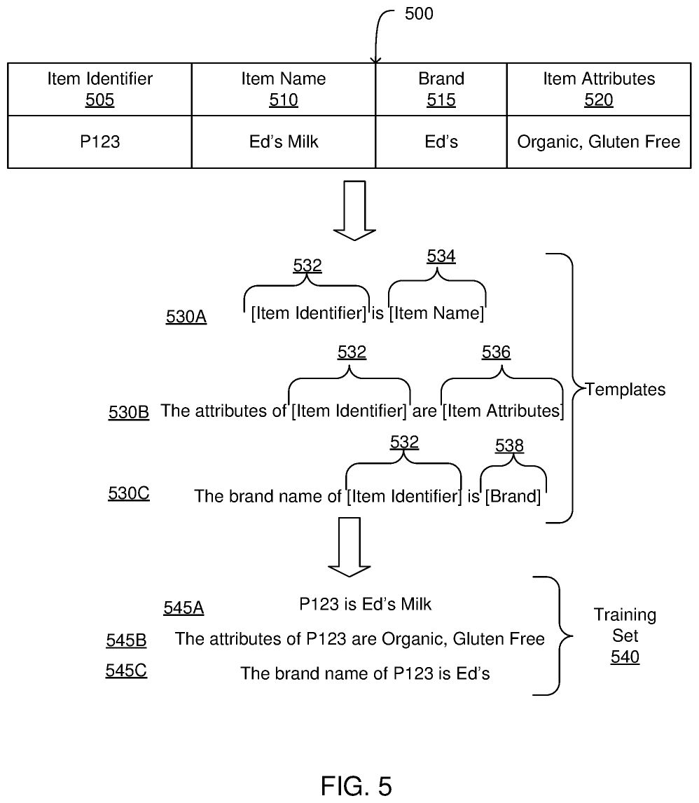

FIG. 5 shows an example generation of examples for the training set from an entry in an item catalog. For purposes of illustration, FIG. 5 shows a single entry 500 of the item catalog, while in various embodiments, the item catalog includes any suitable number of entries. In the example of FIG. 5, the entry 500 of the item catalog includes a field 505 for an item identifier that uniquely identifies an item, a field 510 for an item name that includes a textual name of the item, a field 515 for a brand of the item, and a field 520 including values of one or more attributes of the item.

FIG. 5 shows examples of templates 530A, 530B, 530C (also referred to individually and collectively using reference number 530) maintained by the online concierge system 102 for generating natural language examples identifying attributes of items. In the example of FIG. 5, template 530A corresponds to an item name of an item, template 530B corresponds to attributes of an item, and template 530C corresponds to a brand of an item. Each template 530 comprises a sentence with one or more placeholder positions, with each placeholder position corresponding to a field in the item catalog and identifying a position in the sentence where a value from the item catalog for the corresponding field is inserted. Hence, template 530A includes placeholder position 532 corresponding to the field 505 for item identifier and placeholder position 534 corresponding to the field 510 for item name. Similarly, template 530B includes placeholder position 532 corresponding to the field 505 for item identifier and placeholder position 536 corresponding to the field 520 for one or more attributes of the item, while template 530C includes placeholder position 532 corresponding to the field 505 for item identifier and placeholder position 538 corresponding to the field 510 for item name.

Using the templates 530 and the item catalog, the online concierge system 102 generates a training set 540 from various entries of the item catalog. The training set 540 includes examples 545A, 545B, 545C (also referred to individually and collectively using reference number 545), with each example corresponding to an attribute of an item. To generate the examples, the online concierge system 102 identifies entry 500 from the item catalog and extracts values for different attributes from entry 500 for inclusion into corresponding placeholder positions of one or more templates 530. In the example of FIG. 5, example 545A includes the value of the item identifier from field 505 of entry 500 in placeholder position 532 and includes the value of the item name from field 510 of entry 500 in placeholder position 534. Similarly, example 545B include the value of the item identifier from field 505 of entry 500 in placeholder position 532 and the values of the one or more item attributes from field 520 of entry 500 in placeholder position 536. Example 545C includes the value of the item identifier from field 505 of entry 500 in placeholder position 532 and the value of the item brand from field 515 in placeholder position 538. Hence, each example 545 identifies an attribute of an item and includes a value of the attribute for the item and an item identifier for the item in a natural language format, such as a sentence.

In various embodiments, the online concierge system 102 generates one or more examples for the training set based on prior searches received from users. For example, a template specifies a natural language description of a term in a query received by the online concierge system 102, a warehouse 110 whose items were searched, and item identifiers that were included in one or more orders after a query including the term was received. For example, a template is a sentence “The top five purchased items for the query [term] at [warehouse] are [item identifier], [item identifier], [item identifier], [item identifier], and [item identifier].” In the preceding example, [term] denotes a term included in a query, [warehouse] denotes an identifier of a warehouse 110 that was searched, and [item identifier] denotes item identifiers for items included in orders received by the online concierge system 102 after receiving the query. Additionally, the online concierge system 102 may leverage any suitable source of information about attributes of items. For example, the online concierge system 102, creates 410 templates that specify a natural language description of an item that include an item identifier and identify one or more additional items from a taxonomy of items, as further described above in conjunction with FIG. 2, or from co-occurrences of an item with the one or more additional items in one or more recipes, as further described above in conjunction with FIG. 2. Hence, the templates may generate 415 examples of natural language descriptions attributes of an item or additional items related to the item for the training set from any source maintained by, or accessible by, the online concierge system 102 storing information identifying the item and identifying attributes, as well as values of the attributes.

Referring back to FIG. 4, from the training set of natural language examples including item identifiers and values of attributes for items of the item catalog, the online concierge system 102 trains 420 a corpus model. In various embodiments, the corpus model is a masked language model where certain words, or tokens, in an example of the training set are masked, and the corpus model predicts the words that are masked from unmasked words in the example. For example, the online concierge system 102 replaces certain words in an example of the training set with a mask token, with the example including the one or more mask tokens input into the corpus model, which outputs a predicted word for each mask token. However, in other embodiments, the corpus model is any model configured to receive natural language input comprising one or more tokens (e.g., words) and to map the tokens into embeddings in a vector space.

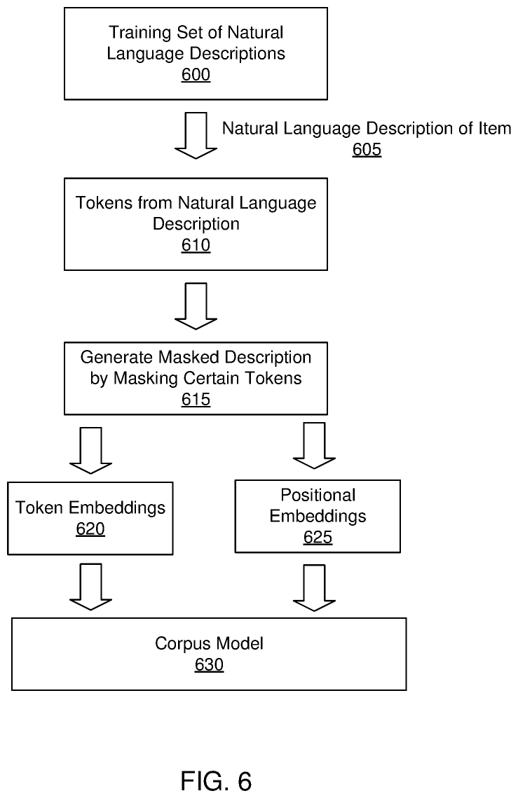

FIG. 6 shows a process flow diagram of one embodiment of training 420 the corpus model. As shown in FIG. 6, the online concierge system 102 generates or obtains a training set 600 including examples of natural language descriptions of items including values of attributes of items from an item catalog. As further described above in conjunction with FIGS. 4 and 5, each example comprises a sentence in which placeholder positions in the sentence were replaced by values of one or more attributes of an item from the item catalog, with a placeholder position identifying an attribute for which a value was obtained. The online concierge system 102 identifies tokens 610 from each natural language description of an item. For example, the online concierge system 102 identifies different words in a natural language description of an item through any suitable technique and identifies each word as a token of the natural language description of the item. In various embodiments, the online concierge system 102, identifies different types of tokens in a natural language description of an item. Example types of tokens include tokens corresponding to natural language terms, tokens corresponding to item identifiers, tokens corresponding to words used for values of certain attributes (e.g., brand names, item names, etc.).

For each token, the online concierge system 102 generates a token embedding 620 representing the token as a vector in a latent space. Where a token corresponds to a word, a token embedding 620 is an embedding for the word. A token embedding 620 may be generated by any suitable method for generating a word embedding, such as Word2Vec, GloVe, as a layer in a neural network trained from the training set 600, or any other suitable method. Hence, the online concierge system 102 determines a token embedding 620 for each token in a natural language description 610 for an item.

Additionally, the online concierge system 102 determines positional embeddings 625 for token embeddings 620. A positional embedding 625 identifies a position of a token within a natural language description 610 for an item. Different positional embeddings 625 correspond to different positions within the natural language description 610 for an item, allowing a positional embedding 625 to identify a position within the natural language description 610 for the item in which a token occurs. Hence, positional embeddings 625 allow the online concierge system 102 to identify an order in which tokens, and their corresponding token embeddings 620, occur in a natural language description 610 for an item. In various embodiments, the positional embeddings 625 provide information identifying relative positions of tokens in the natural language description 610 for the item, while in other embodiments the positional embeddings 625 identify absolute positions of tokens in the natural language description 610 for the item. The positional embeddings 625 may be determined using any suitable method in various embodiments. For example, positional embeddings 625 are frequency-based positional embeddings. In various embodiments, the positional embeddings 625 and the token embeddings 620 have an equal number of dimensions.

The corpus model 630 is a masked language model in various embodiments that receives an input of a natural language description 610 for an item. The input to the corpus model 630 is a combination of a token embedding 620 for each token of the natural language description 610 for the item and a positional embedding 625 corresponding to a position in the natural language description 610 for the item of the token. One or more tokens in the natural language description 610 for the item are replaced with a mask token, with the natural language description 610 with the mask token replacing one or more tokens provided as input to the corpus module 630. In some embodiments, for each position in the natural language description 610 for the item, the online concierge system 102 sums a positional embedding 625 for the position and a token embedding 620 for the token located in the position, with the corpus model 630 receiving as input a combination of positional embeddings 625 and corresponding token embeddings 620 for a natural language description 620 of the item.

For an example of the training data (which includes a natural language description 610 for an item with one or more tokens replaced with a mask token), application of the corpus model 630 generates a predicted token for each mask token in the example. The online concierge system 102 determines an error term from a difference between a predicted token for a mask token and the token at the position corresponding to the mask token in the example. The error term may be generated through any suitable loss function, or combination of loss functions, in various embodiments. For example, the loss function is a cross-entropy loss between a predicted token for a mask token at a position in the example and a token at the position in the example. However, in other embodiments, any loss function or combination of loss functions, may be applied to the predicted token for a mask token at a position in the example and a token at the position in the example to generate the error term.

The online concierge system 102 backpropagates the one or more error terms through layers of a network comprising the corpus model 630. One or more parameters of the network are modified through any suitable technique from the backpropagation of the one or more error terms through the layers of the network. For example, weights between nodes of the network, such as nodes in different layers of the network, are modified to reduce the one or more error terms. The backpropagation of the one or more error terms is repeated by the online concierge system 102 until the one or more loss functions satisfy one or more criteria. For example, the one or more criteria specify conditions for when the backpropagation of the one or more error terms through the layers of the network is stopped. In some embodiments, the online concierge system 102 uses gradient descent or any other suitable process to minimize the one or more error terms in various embodiments.

In response to the one or more loss functions satisfying the one or more criteria and the online concierge system 102 stopping the backpropagation of the one or more error terms, the online concierge system 102 stores the set of parameters for the layers of the corpus model 630. For example, the online concierge system 102 stores the weights of connections between nodes in the network as the set of parameters of the network in a non-transitory computer readable storage medium. Hence, training of the corpus model 630 allows the online concierge system 102 to generate and to store a neural network, or other machine learning model, that predicts a token for a position in an input natural language description 610 for an item from tokens at other positions in the natural language description 610 for the item. In various embodiments, the online concierge system 102 applies the corpus model 630 to each example comprising a natural language description 610 for an item of the training set 600 to train the corpus model 630, while in other embodiments the online concierge system 102 applies the corpus model 630 to any suitable number of examples of the training set 600 to train the corpus model 630.

Referring back to FIG. 4, the online concierge system 102 also obtains 425 selection training data from prior searches performed by users. The selection training data includes selection examples that each include a query term and a plurality of pairs that each include an item identifier and an affinity score between an item corresponding to the item identifier and the query term. In various embodiments, a selection example includes a pair for each combination of item identifier of an item in the item catalog and the affinity score between the item corresponding to the item identifier and the query term. The affinity score between the item corresponding to the item identifier and the query term may be determined from rates at which users selected the item via the online concierge system 102 after providing the query term to the online concierge system 102. In other embodiments, the affinity score may be specified by one or more reviewers of the online concierge system 102 or determined through any suitable method.

After training 420 the corpus model from the natural language descriptions for items of the training set, the online concierge system 102 trains 430 a mapping layer that receives the output of the corpus model. The mapping layer is a linear layer with a number of outputs equal to a number of unique item identifiers of the item catalog. In various embodiments, the online concierge system 102 trains 430 the mapping layer as a multiclass multilabel classification, with a number of classes that equals the number of unique item identifiers of the item catalog. In various embodiments, the mapping layer has an output node corresponding to each item identifier of the item catalog, with a weight between an output node and the output of the corpus model based on a token embedding for the item identifier corresponding to the output node. Hence, the output of the mapping layer is a predicted similarity between the output of the corpus model and each item identifier of the item catalog, allowing the mapping layer to determine predicted similarities between the output of the corpus model, which is an embedding for the input of the corpus model that is a query term, and each item identifier of the item catalog in a single iteration. In contrast, conventional search methods encode the received query term, individually encode different items of the item catalog, and determines similarities between the received query term and the individually encoded items.

To train 430 the mapping layer, the online concierge system 102 applies the model, which comprises the trained corpus model and the mapping layer, to a selection example of the selection training data. The online concierge system 102 determines one or more error terms from differences between a predicted similarity between a query term of the selection example and an item identifier output by the model and the affinity of the query term for the item identifier included in the selection example. In various embodiments, the predicted similarity between the query term and the item identifier is a dot product between the embedding of the query term from the corpus model and an embedding of the item identifier, which is a weight of a connection between the corpus model and an output node for the item identifier; in other embodiments, the measure of similarity is a cosine similarity, a Euclidean distance, or any other suitable value. An error term may be generated through any suitable loss function, or combination of loss functions, in various embodiments. For example, the loss function is a cross-entropy loss or a mean squared error between a predicted similarity between a query term of the selection example and an item identifier output by the model and the affinity of the query term for the item identifier included in the example. However, in other embodiments, any loss function or combination of loss functions, may be applied to the predicted similarity between the query term of the example and the item identifier output by the model and the affinity of the query term for the item identifier included in the selection example to generate an error term.

The online concierge system 102 backpropagates the one or more error terms through the mapping layer. One or more parameters of the mapping layer are modified through any suitable technique from the backpropagation of the one or more error terms through the layers of the network. For example, weights between the output of the corpus model and output nodes are modified to reduce the one or more error terms. The backpropagation of the one or more error terms is repeated by the online concierge system 102 until the one or more loss functions satisfy one or more criteria. For example, the one or more criteria specify conditions for when the backpropagation of the one or more error terms through the mapping layer is stopped. In some embodiments, the online concierge system 102 uses gradient descent or any other suitable process to minimize the one or more error terms in various embodiments.

In response to the one or more loss functions satisfying the one or more criteria and the online concierge system 102 stopping the backpropagation of the one or more error terms, the online concierge system 102 stores the set of parameters for the mapping layer. For example, the online concierge system 102 stores the weights of connections between nodes in the network as the set of parameters of the mapping layer in a non-transitory computer readable storage medium. Hence, training of the mapping layer allows the online concierge system 102 to generate and to store a neural network, or other machine learning model, that predicts a similarity of a query term to each of multiple item identifiers. In various embodiments, the online concierge system 102 applies the model to each selection example of the selection training data, while in other embodiments the online concierge system 102 applies the model to any suitable number of selection examples of the selection training data.

After training 430 the mapping layer, the online concierge system 102 receives 435 a query including one or more terms. In various embodiments, the query comprises a query token comprising a word or phrase indicating that subsequent tokens are terms in a query. The online concierge system 102 generates an embedding for a term in the query from the trained corpus model. The embedding for the term generated by the corpus model is input into the mapping layer, which generate 440 a predicted similarity between the embedding for the term of the query and each item identifier, based on the token embedding corresponding to each item identifier. The online concierge system 102 selects 445 a set of items based on the predicted similarities. For example, the online concierge system 102 ranks items based on the predicted similarity of their corresponding item identifier to the embedding for the term of the query and selects 445 items having item identifiers having at least a threshold position in the ranking (e.g., having item identifiers within the top 10 positions of the rankings) and displays 450 information identifying the selected items to a user via an interface. In other embodiments, the online concierge system 102 displays information identifying various items in an order corresponding to the ranking of items based on the predicted similarities of their corresponding item identifiers to the embedding for the term of the query.

FIG. 7 is a process flow diagram of one embodiment of a model 700 for identifying items from a database satisfying a query from predicted similarities between items in the database and a term in a query. As shown in FIG. 7, the online concierge system 102 receives a query 705 including one or more terms. In various embodiments, the query includes a query token identifying that the query is to identify item identifiers based on one or more terms included in the query in addition to the query token. As further described above in conjunction with FIG. 6, the online concierge system 102 identifies individual tokens 710 from the query. In various embodiment, a token 710 corresponds to a word included in the query 705. Also as described above in conjunction with FIG. 6, the online concierge system 102 determines token embeddings 715 for each identified token 710 and positional embeddings 720 identifying positions of each token 710 in the query 705.

The model 700 includes the corpus model 630, further described above in conjunction with FIGS. 4 and 6, and a mapping layer 725, as further described above in conjunction with FIG. 4. The corpus model 630 receives a combination of the token embeddings 715 and the positional embeddings 720 for the tokens 710 in the query 705. For example, for each position in the query, the corpus model 630 receives a sum of the token embedding 715 of a token located at the position and a positional embedding 720 corresponding to the position, as further described above in conjunction with FIG. 6; however, in other embodiments, the corpus model 630 receives any suitable combination of the token embedding 715 for a token 710 and a positional embedding 720 for a position including the token 710 for each token 710 identified in the query 705. The corpus model 630 outputs an embedding for a token 710 determined from its token embedding 715 and positional embedding 720, as well as token embeddings 715 and positional embeddings 720 for other tokens 710 in the query 705.

The embedding for the token 710 output by the corpus model 630 is input to the mapping layer 725, which connects the output of the corpus model 630 to nodes corresponding to each item of the item catalog. A connection between the output of the corpus model 630 and a node corresponding to an item of the item catalog has a weight that is the embedding of the item identifier of the item (or that is based on the embedding of the item identifier of the item). The mapping layer 725 generates a predicted similarity 730A of the embedding for a term of the query 705 to the embeddings of the item identifier of an item. In various embodiments, a predicted similarity 730A is a dot product, of the embedding for the term of the query 705 and an embedding of the item identifier of an item. The mapping layout 725 outputs predicted similarities 730A-730N of the term of the query 705 to each item identifier of an item included in the product catalog. Based on the predicted similarities 730A-730N, the model 700 selects a set of items 740 for display. For example, the model 700 ranks the items based on the predicted similarity 730A-730N generated for each item identifier corresponding to an item and selects a set of items 740 having at least a threshold position in the ranking for display. Alternatively, the model 700 determines an order in which items are displayed based on the ranking.

While FIGS. 4 and 7 describe using the corpus model and the mapping layer to select items for display based on a query term, the corpus model and the mapping layer may additionally or alternatively be trained to output items that are related to an item identifier that the corpus model receives as input. In various embodiments, the online concierge system 102 trains 430 the mapping layer as a multiclass multilabel classification, with a number of classes that equals the number of unique item identifiers of the item catalog. As described above, the mapping layer has an output node corresponding to each item identifier of the item catalog, with a weight between an output node and the output of the corpus model based on a token embedding for the item identifier corresponding to the output node. Hence, the output of the mapping layer is a predicted similarity between the output of the corpus model and each item identifier of the item catalog, allowing the mapping layer to determine predicted similarities between the output of the corpus model, which is an embedding for the input of the corpus model that is an item identifier, and each item identifier of the item catalog in a single iteration. In contrast, conventional search methods encode the received query term, individually encode different items of the item catalog, and determines similarities between the received query term and the individually encoded items.

To train the mapping layer, the online concierge system 102 applies the model, comprising the trained corpus model and the mapping layer, to an example of relationship training data. The relationship training data includes a plurality of examples, with each example comprising an item identifier and pairs that each include an additional item identifier and an affinity score between an item corresponding to the item identifier and an additional item corresponding to the additional item identifier. The affinity score between the item corresponding to the item identifier and the additional item corresponding to the additional item identifier query term may be determined from rates at which the item and the additional item co-occur in orders previously received from users of the online concierge system 102 or co-occur in orders previously fulfilled by the online concierge system 102. The online concierge system 102 normalizes the rate or the frequency at which the item and the additional item co-occur in previously received orders to determine the affinity score between the item and the additional item in various embodiments. In some embodiments, the online concierge system 102 determines the rate or the frequency of co-occurrence of the item and the additional item in orders received or fulfilled during a specific time interval (e.g., within a threshold amount of time from a current item).

The online concierge system 102 determines one or more error terms from differences between a predicted similarity between an item identifier of the example and an additional item identifier output by the model and the affinity score between the item identifier and the additional item identifier included in the example. An error term may be generated through any suitable loss function, or combination of loss functions, in various embodiments. For example, the loss function is a cross-entropy loss or a mean squared error between a predicted similarity between predicted similarity between an item identifier of the example and an additional item identifier output by the model and the affinity score between the item identifier and the additional item identifier included in the example. However, in other embodiments, any loss function or combination of loss functions, may be applied to the predicted similarity between an item identifier of the example and the additional item identifier output by the model and the affinity score between the item identifier and the additional item identifier included in the example to generate an error term.

The online concierge system 102 backpropagates the one or more error terms through the mapping layer. One or more parameters of the mapping layer are modified through any suitable technique from the backpropagation of the one or more error terms through the layers of the network. For example, weights between the output of the corpus model and output nodes are modified to reduce the one or more error terms. The backpropagation of the one or more error terms is repeated by the online concierge system 102 until the one or more loss functions satisfy one or more criteria. For example, the one or more criteria specify conditions for when the backpropagation of the one or more error terms through the mapping layer is stopped. In some embodiments, the online concierge system 102 uses gradient descent or any other suitable process to minimize the one or more error terms in various embodiments.

In response to the one or more loss functions satisfying the one or more criteria and the online concierge system 102 stopping the backpropagation of the one or more error terms, the online concierge system 102 stores the set of parameters for the mapping layer. For example, the online concierge system 102 stores the weights of connections between nodes in the network as the set of parameters of the mapping layer in a non-transitory computer readable storage medium. Hence, training of the mapping layer allows the online concierge system 102 to generate and to store a neural network, or other machine learning model, that predicts a similarity of an item identifier to each of multiple additional item identifiers, such as to each additional item identifier in the item catalog. In various embodiments, the online concierge system 102 applies the model to each example of the relationship training data, while in other embodiments the online concierge system 102 applies the model to any suitable number of examples of the relationship training data.

In various embodiments, the online concierge system 102 subsequently applies the model comprising the corpus model and the trained mapping layer to a received specific item identifier, generating predicted similarities between the specific item identifier and each item in the item catalog. As further described above, based on the predicted similarities, the online concierge system 102 selects one or more items for display or determines an order in which to display items of the item catalog. For example, the online concierge system 102 ranks items of the item catalog based on their predicted similarity to the received item identifier and selects items having at least a threshold position in the ranking for display or displays items of the item catalog in an order based on the ranking. In various embodiments, the model receives an input comprising a recommendation token and an item identifier, with the recommendation token indicating that one or more subsequent tokens in the received input are item identifiers. Hence, the online concierge system 102 may receive a query and determine whether tokens in the query are terms (e.g., words or other natural language expressions) or are item identifiers based on whether the query includes the query token or includes the recommendation token, respectively.

Additionally, to account for new products, the online concierge system 102 receives an input string including a token signaling addition of a new product to the stored embeddings. For example, the input includes a token identifying addition of a new product to signal that the subsequent tokens are attributes of a new item. The corpus model is applied to the received input, generating an output that is an embedding corresponding to the new item. The online concierge system 102 subsequently stores the embedding corresponding to the new item in association with an item identifier generated for the new item. The online concierge system 102 also updates the mapping layer to include an output node corresponding to the new item, with a weight of a connection between the corpus model and the output node corresponding to the new item determined as the embedding for the new item output by the corpus model. This allows the online concierge system 102 to update the model to account for new items without fully retraining the model, simplifying modification of the model to account for new items.

While FIGS. 4-7 describe generation and application of a model determining measures of similarity between an input query and multiple items in an item catalog, the method described in conjunction with FIGS. 4-7 may be used to generate a model determining measures of similarity between an input query and multiple content items (e.g., documents, web pages, articles) in a database or other relational table. For example, an online system (e.g., the online concierge system 102, a search provider, a server providing content to users, etc.) maintains a database or other relational table identifying multiple content items. Each content item is associated with a content item identifier, and the database includes an entry for a content item identifier having fields corresponding to different attributes of a content item, with a value of the attribute stored in the field of the entry for the content item. As further described above in conjunction with FIG. 4, the online system creates one or more templates for natural language descriptions of attributes for each content item of the database. Each template includes a content item identifier of a content item, a description of an attribute, a value of the attribute for the content item, and natural language text. From the templates and the database, the online concierge system generates examples for a training set, with each example including a plurality of tokens in different positions and corresponding to a content item, with values of one or more tokens generated from values of one or more attributes of the content item from the database. The online concierge system 102 trains a corpus model to receive a natural language description of a content item and to output one or more embeddings in a vector space for one or more tokens in the natural language description of the content item, such as by backpropagating one or more error terms from a difference between a predicted token generated for a position of an example to which the corpus model was applied and the token at the position of the example until a loss function satisfies one or more criteria, as further described above in conjunction with FIGS. 4 and 6. The online system obtains selection training data from prior searches for content items that the online system received, with the selection training data including multiple selection examples. A selection example includes a query term that was included in a prior search and a plurality of pairs, with each pair including a content item identifier and an affinity score between the content item identifier and the query term. In various embodiments, a selection example includes a pair for each content item of the database. The online system trains a model comprising the corpus model and a mapping layer that receives an embedding output from the corpus model and outputs a predicted similarity of the embedding output from the corpus model to content item embeddings for each content item of the database. As further described above in conjunction with FIG. 4, the online system trains the model by applying the model to each selection example and modifying one or more parameters of the mapping layer by backpropagating an error term from a difference between a predicted similarity of a selection example to a content item embedding and an affinity score between the query term of the selection example and the content item embedding until a loss function satisfies one or more criteria, as further described above in conjunction with FIG. 4. The trained model is stored and subsequently receives a query and determines predicted similarities between the query and each content item of the database, as further described above in conjunction with FIG. 4.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
obtaining, at the online concierge system, an item catalog for one or more warehouses, the item catalog for a warehouse identifying items offered by the warehouse and attributes of each item offered by the warehouse;
creating one or more templates for natural language descriptions of attributes for each item of the item catalog, each including the item identifier of an item, a description of an attribute, a value of the attribute for the item, and natural language text;
generating a training set including one or more examples comprising natural language descriptions of items of the item catalog and values of one or more attributes for the item from the one or more templates and the item catalog, each example corresponding to the item and including a plurality of tokens in positions, with values of one or more tokens determined from values of one or more attributes of the item;
training a corpus model to receive a natural language description of the item and to output one or more embeddings in a vector space for one or more tokens in the natural language description of the item by:
applying the corpus model to each example of the training set and backpropagating one or more error terms based on a difference between a predicted token generated by the corpus model for a position of an example and a token included at the position of the example until one or more loss functions satisfy one or more criteria;
obtaining selection training data from prior searches for items obtained by the online concierge system, the selection training data comprising a plurality of selection examples, a selection example including a query term and a plurality of pairs that each include an item identifier and an affinity score between an item corresponding to the item identifier and the query term;
training a model comprising the corpus model and a mapping layer that receives an embedding from the corpus model and outputs a predicted similarity of the embedding to item embeddings for each item of the item catalog by:
applying the model to each selection example of the training set and backpropagating one or more error terms based on a difference between a predicted similarity between the embedding from the corpus model and an item embedding and the affinity score between the query term of the selection example and the item embedding until one or more loss functions satisfy one or more criteria; and
storing parameters comprising the trained model on a computer readable storage medium.

2. The method of claim 1, further comprising:
receiving a query including a term;
generating a predicted similarity between each item of the item catalog and the term included in the query by applying the trained model to the received query;
selecting a set of items of the item catalog based on the predicted similarities; and
displaying the set of items.

3. The method of claim 2, wherein selecting the set of items of the item catalog based on the predicted similarities comprises:
ranking the items of the item catalog based on the predicted similarities; and
selecting items having at least a threshold position in the ranking.

4. The method of claim 1, further comprising:
receiving a query including a term;
generating a predicted similarity between each item of the item catalog and the term included in the query by applying the trained model to the received query; and
displaying the items of the item catalog in an order based on the predicted similarities.

5. The method of claim 1, further comprising:
obtaining relationship training data from prior orders received by the online concierge system, the relationship training data comprising a plurality of relationship examples, a relationship example including the item identifier and a plurality of pairs that each include an additional item identifier and an affinity score between the item corresponding to the item identifier and an additional item corresponding to the additional item identifier;
training the model comprising the corpus model and the mapping layer that receives the embedding from the corpus model and outputs the predicted similarity of the embedding to item embeddings for each item of the item catalog by:
applying the model to each selection example of the training set and backpropagating one or more error terms based on a difference between a predicted similarity between the embedding from the corpus model and the additional item embedding and the affinity score between the item embedding of the relationship example and the additional item embedding until one or more loss functions satisfy one or more criteria; and
storing parameters comprising the trained model on the computer readable storage medium.

6. The method of claim 5, further comprising:
receiving a query including a specific item identifier
generating a predicted similarity between each item of the item catalog and the specific item identifier included in the query by applying the trained model to the received query; and
displaying items of the item catalog based on the predicted similarities.

7. The method of claim 6, wherein displaying items of the item catalog based on the predicted similarities comprises:
ranking the items of the item catalog based on the predicted similarities;
selecting items having at least a threshold position in the ranking; and
displaying the set of items.

8. A method comprising:
maintaining, at an online system, a database of content items, the database identifying each content item and values of one or more attributes of each content items;
creating one or more templates for natural language descriptions of attributes for each content item of the database, each including a content item identifier of a content item, a description of an attribute, a value of the attribute for the content item, and natural language text;
generating a training set including one or more examples comprising natural language descriptions of content items of the database and values of one or more attributes for the content item from the one or more templates and the item catalog, each example corresponding to the content item and including a plurality of tokens in positions, with values of one or more tokens determined from values of one or more attributes of the content item;
training a corpus model to receive a natural language description of the content item and to output one or more embeddings in a vector space for one or more tokens in the natural language description of the content item by:
applying the corpus model to each example of the training set and backpropagating one or more error terms based on a difference between a predicted token generated by the corpus model for a position of an example and a token included at the position of the example until one or more loss functions satisfy one or more criteria;
obtaining selection training data from prior searches for content items obtained by the online system, the selection training data comprising a plurality of selection examples, a selection example including a query term and a plurality of pairs that each include a content item identifier and an affinity score between a content item corresponding to the item identifier and the query term;
training a model comprising the corpus model and a mapping layer that receives an embedding from the corpus model and outputs a predicted similarity of the embedding to content item embeddings for each content item of the database by:
applying the model to each selection example of the training set and backpropagating one or more error terms based on a difference between a predicted similarity between the embedding from the corpus model and a content item embedding and the affinity score between the query term of the selection example and the content item embedding until one or more loss functions satisfy one or more criteria; and
storing parameters comprising the trained model on a computer readable storage medium.

9. The method of claim 8, further comprising:
receiving a query including a term;
generating a predicted similarity between each content item of the database and the term included in the query by applying the trained model to the received query;
selecting a set of items of the database based on the predicted similarities; and
displaying the set of items.

10. The method of claim 9, wherein selecting the set of content items of the database based on the predicted similarities comprises:
ranking the content items of the database based on the predicted similarities; and
selecting items having at least a threshold position in the ranking.

11. The method of claim 8, further comprising:
receiving a query including a term;
generating a predicted similarity between each content item of the database and the term included in the query by applying the trained model to the received query; and
displaying the items of the database in an order based on the predicted similarities.

12. A computer program product comprising a non-transitory computer readable storage medium having instructions encoded thereon that, when executed by a processor, cause the processor to:
obtain, at the online concierge system, an item catalog for one or more warehouses, the item catalog for a warehouse identifying items offered by the warehouse and attributes of each item offered by the warehouse;
create one or more templates for natural language descriptions of attributes for each item of the item catalog, each including the item identifier of an item, a description of an attribute, a value of the attribute for the item, and natural language text;
generate a training set including one or more examples comprising natural language descriptions of items of the item catalog and values of one or more attributes for the item from the one or more templates and the item catalog, each example corresponding to the item and including a plurality of tokens in positions, with values of one or more tokens determined from values of one or more attributes of the item;
train a corpus model to receive a natural language description of the item and to output one or more embeddings in a vector space for one or more tokens in the natural language description of the item by:
applying the corpus model to each example of the training set and backpropagating one or more error terms based on a difference between a predicted token generated by the corpus model for a position of an example and a token included at the position of the example until one or more loss functions satisfy one or more criteria;
obtain selection training data from prior searches for items obtained by the online concierge system, the selection training data comprising a plurality of selection examples, a selection example including a query term and a plurality of pairs that each include an item identifier and an affinity score between an item corresponding to the item identifier and the query term;
train a model comprising the corpus model and a mapping layer that receives an embedding from the corpus model and outputs a predicted similarity of the embedding to item embeddings for each item of the item catalog by:
applying the model to each selection example of the training set and backpropagating one or more error terms based on a difference between a predicted similarity between the embedding from the corpus model and an item embedding and the affinity score between the query term of the selection example and the item embedding until one or more loss functions satisfy one or more criteria; and
store parameters comprising the trained model on a computer readable storage medium.

13. The computer program product of claim 12, wherein the non-transitory computer readable storage medium further has instructions encoded thereon that, when executed by the processor, cause the processor to:
receive a query including a term;
generate a predicted similarity between each item of the item catalog and the term included in the query by applying the trained model to the received query;
select a set of items of the item catalog based on the predicted similarities; and
display the set of items.

14. The computer program product of claim 13, wherein select the set of items of the item catalog based on the predicted similarities comprises:
rank the items of the item catalog based on the predicted similarities; and
select items having at least a threshold position in the ranking.

15. The computer program product of claim 12, wherein the non-transitory computer readable storage medium further has instructions encoded thereon that, when executed by the processor, cause the processor to:
receive a query including a term;
generate a predicted similarity between each item of the item catalog and the term included in the query by applying the trained model to the received query; and
display the items of the item catalog in an order based on the predicted similarities.

16. The computer program product of claim 12, wherein the non-transitory computer readable storage medium further has instructions encoded thereon that, when executed by the processor, cause the processor to:
obtain relationship training data from prior orders received by the online concierge system, the relationship training data comprising a plurality of relationship examples, a relationship example including the item identifier and a plurality of pairs that each include an additional item identifier and an affinity score between the item corresponding to the item identifier and an additional item corresponding to the additional item identifier;
train the model comprising the corpus model and the mapping layer that receives the embedding from the corpus model and outputs the predicted similarity of the embedding to item embeddings for each item of the item catalog by:
applying the model to each selection example of the training set and backpropagating one or more error terms based on a difference between a predicted similarity between the embedding from the corpus model and the additional item embedding and the affinity score between the item embedding of the relationship example and the additional item embedding until one or more loss functions satisfy one or more criteria; and
store parameters comprising the trained model on the computer readable storage medium.

17. The computer program product of claim 16, wherein the non-transitory computer readable storage medium further has instructions encoded thereon that, when executed by the processor, cause the processor to:
receive a query including a specific item identifier
generate a predicted similarity between each item of the item catalog and the specific item identifier included in the query by applying the trained model to the received query; and
display items of the item catalog based on the predicted similarities.

18. The computer program product of claim 17, wherein display items of the item catalog based on the predicted similarities comprises:
rank the items of the item catalog based on the predicted similarities;
select items having at least a threshold position in the ranking; and
display the set of items.
